(19) United States
(12) Patent Application Publication
(10) Pub. No.: US 2018/0253085 A1
(43) Pub. Date: Sep. 6, 2018

(54) INTEGRATED SOLUTION FOR SIMULATION-BASED PRODUCTION OF SHIPS AND OFFSHORE PLANTS

(71) Applicant: Korea Institute of Ocean Science & Technology, Ansan (KR)

(72) Inventor: Ho Jin HWANG, Daejeon (KR)

(21) Appl. No.: 15/451,237

(22) Filed: Mar. 6, 2017

(51) Int. Cl. G05B 19/418

(52) U.S. Cl. CPC G05B 19/41885; G05B 2219/31001; G05B 2219/31343; G05B 19/4188

(57) ABSTRACT

Disclosed is a simulation system technology specific to the production of ships and offshore plants, whereby the building process and method verification of ships and offshore plants, optimization and verification of facilities and layout, and optimization of production management can be simulated.

### BACKGROUND OF THE INVENTION

### Field of the Invention

The present invention relates to a simulation system technology specific to the production of ships and offshore plants, whereby the building process and method verification of ships and offshore plants, optimization and verification of facilities and layout, and optimization of production management can be simulated.

### Description of the Related Art

High-efficiency production technology has emerged as one strategy for achieving a technological competitive advantage in the shipbuilding and marine industry, and currently, shipyards are making efforts to develop and apply new production technologies and new building methods. As an example of a new technology, a simulation technology to support verification of new methods and optimized production flow is receiving much attention. However, due to specificity of the shipbuilding and marine industry, which is an engineering-to-order industry, there is a limit to directly applying simulation systems and tools for make-to-stock, order industry, such as machinery, automotive, and aerospace, to the shipbuilding and marine industry, so a production simulation technology specialized in shipyard is required.

To meet this need, a study is underway to develop a simulation system for production for ships and offshore plants, which combines IT simulation technology with a traditional shipyard. This study is referred to as a simulation of production for ships and offshore plants framework that systematically integrates sporadically developed production simulation programs. The purpose of this study is to design and develop a module with high recyclability considering scalability. In order to develop an integrated solution by designing the simulation framework for production of ships and offshore plants, it is firstly required to positively reflect on-site requirements in the shipbuilding and marine industry and solve them technically.

At this level, a large number of production simulation programs have been developed in existing large shipyards. These programs are usually developed by the needs and necessity of demand departments and are helping to improve productivity. However, conventional simulations for production of ships and offshore plants are being developed individually and locally by demand departments, and as such they are being developed/operated with different structures. Due to individual developments and different structures, the conventional simulations have drawbacks in terms of module recyclability and reusability.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is intended to propose an integrated solution for simulation-based production of ships and offshore plants, the integrated solution configured such that a simulation framework for production of ships and offshore plants can be universally applied regardless of different shipyard environments and is separably combined to a planning validation simulation system, a crane block lifting and erection simulation system, a GIS-based dock and quay simulation system, and a block monitoring and logistics simulation system, all of which are utilized in a integrated solution based on the simulation framework for production of ships and offshore plants but are applied differently according to different environments of each shipyard, whereby the integrated solution has scalability and recyclability to be effectively applied to the unique situations of individual shipyards.

In order to achieve the above object, according to one aspect of the present invention, there is provided an integrated solution for simulation-based production of ships and offshore plants, the integrated solution being based on a simulation framework for production of ships and offshore plants, the simulation framework including:

a simulation engine configured to calculate and analyze a simulation according to interaction of kernels, as an analysis interpretation module including mathematical calculation;

a visualization engine configured to allow a visualization object calculated in the simulation engine to be represented in a same view (viewpoint) from a user's point of view; and

an analysis engine configured to provide an expression function for analysis results of the simulation engine, and to use results calculated in the simulation engine as neutral output data, the integrated solution including:

a planning validation simulation system configured to support mutual verification of production process planning and production scheduling from an integrated viewpoint of production planning, according to the calculation and analysis results of the simulation engine;

a crane block lifting and erection simulation system configured to support verification of a lug position, simulation of block defamation and stress, simulation of interaction between a floating crane and a floating dock, and motion simulation of blocks when lifting for verification and planning of operations, such as block turn-over and block lifting required for the production of ships and offshore plants, block supporter placement in the dock, marine erection, according to the calculation and analysis results of the simulation engine;

a GIS-based dock and quay simulation system configured to support placement of a dry dock and a quay wall required for the production of ships and offshore plants, and optimization of facility operation, based on geographical information within a shipyard according to the calculation and analysis results of the simulation engine; and

a block monitoring and logistics simulation system configured to support loading of steel plate and section steel, locating and transportation planning of processing logistics, subsidiary materials, assembly blocks, design equipment, and single items, standard production plans for block allocation and layout by lot number of an assembly plant and a pre-erection yard, block layout planning for a painting factory, and block layout planning for quay outfitting, according to the calculation and analysis results of the simulation engine, wherein

the simulation framework for the production of ships and offshore plants, the planning validation simulation system, the crane block lifting and erection simulation system, the GIS-based dock and quay simulation system, and the block monitoring and logistics simulation system are separable from each other.

The present invention is an integrated solution for simulation-based production of ships and offshore plants, whereby the solution is developed in an independent form to be applied to all large and small shipyards, whereby based on various production simulations, it is possible to simulate the building process and method verification of ships and offshore plants, optimization and verification of facilities and layout, and optimization of production management in the shipyard, and based on this, it is possible to support pre-verification, decision-making during work, and post-management.

### DETAILED DESCRIPTION OF THE INVENTION

Hereinbelow, exemplary embodiments of the present invention will be described in detail with reference to the accompanying drawings. Throughout the drawings, the same reference numerals will refer to the same or like parts.

The present invention is intended to propose an integrated solution for simulation-based production of ships and offshore plants, the integrated solution configured such that a simulation framework for production of ships and offshore plants can be universally applied regardless of different shipyard environments and is separably combined to a planning validation simulation system, a crane block lifting and erection simulation system, a GIS-based dock and quay simulation system, and a block monitoring and logistics simulation system, all of which are utilized in a integrated solution based on the simulation framework for production of ships and offshore plants but are applied differently according to different environments of each shipyard, whereby the integrated solution has scalability and recyclability to be effectively applied to the unique situations of individual shipyards.

In order to achieve the above object, the present invention provides an integrated solution for simulation-based production of ships and offshore plants, the integrated solution being based on a simulation framework for production of ships and offshore plants, the simulation framework including:

a simulation engine configured to calculate and analyze a simulation according to interaction of kernels, as an analysis interpretation module including mathematical calculation;

a visualization engine configured to allow a visualization object calculated in the simulation engine to be represented in a same view (viewpoint) from a user's point of view; and

an analysis engine configured to provide an expression function for analysis results of the simulation engine, and to use results calculated in the simulation engine as neutral output data, the integrated solution including:

a planning validation simulation system configured to support mutual verification of production process planning and production scheduling from an integrated viewpoint of production planning, according to the calculation and analysis results of the simulation engine;

a crane block lifting and erection simulation system configured to support verification of a lug position, simulation of block defamation and stress, simulation of interaction between a floating crane and a floating dock, and motion simulation of blocks when lifting for verification and planning of operations, such as block turn-over and block lifting required for the production of ships and offshore plants, block supporter placement in the dock, marine erection, according to the calculation and analysis results of the simulation engine;

a GIS-based dock and quay simulation system configured to support placement of a dry dock and a quay wall required for the production of ships and offshore plants, and optimization of facility operation, based on geographical information within a shipyard according to the calculation and analysis results of the simulation engine; and

a block monitoring and logistics simulation system configured to support loading of steel plate and section steel, locating and transportation planning of processing logistics, subsidiary materials, assembly blocks, design equipment, and single items, standard production plan for block allocation and layout by lot number of an assembly plant and a pre-erection yard, block layout planning for a painting factory, and block layout planning for quay outfitting, according to the calculation and analysis results of the simulation engine, wherein

the simulation framework for the production of ships and offshore plants, the planning validation simulation system, the crane block lifting and erection simulation system, the GIS-based dock and quay simulation system, and the block monitoring and logistics simulation system are separable from each other.

In the present invention, a set of calculation and analysis modules represented by a kernel is configured as a simulation engine to enable mutual information exchange and sharing, and the simulation engine and the application system, that is, the planning validation simulation system, the crane block lifting and erection simulation system, the GIS-based dock and quay simulation system, and the block monitoring and logistics simulation system are separated from each other. Thereby, it is possible to secure scalability, and possible to develop new an application system by combination of kernels in the simulation engine, and further, the present invention may be applied according to each shipyard situations. The present invention has a framework structure independent from the application system, whereby the application system can be customized to have a user friendly process and GUI suitable for each shipyard environment.

The simulation framework for production of ships and offshore plants according to the present invention, as a concept that is introduced for configuration of various application simulation technologies, is a simulation system technology for ships and offshore plants, whereby the building process and method verification of ships and offshore plants, optimization and verification of facilities and layout, and optimization of production management can be simulated. The simulation framework for production of ships and offshore plants is capable of supporting pre-verification, decision-making during work, and post-management based on various production simulations, and is developed in an independent form to be applied to all shipyards. Based on this, individual shipyard can develop an application program suitable for its unique environment, whereby it is possible to use the simulation framework in all shipyards.

The present invention provides the following application systems, as typical application fields of a shipyard, based on the simulation framework for production of ships and offshore plants: the planning validation simulation; the crane block lifting and erection simulation; the GIS-based dock and quay simulation; and block monitoring and logistics simulation.

Herein, the planning validation simulation is configured to support mutual verification of production process planning and production scheduling from an integrated viewpoint of production planning. Further, the crane block lifting and erection simulation system is configured to support verification of a lug position, simulation of block deformation and stress, simulation of interaction between a floating crane and a floating dock, and motion simulation of blocks when lifting for verification and planning of operations, such as block turn-over and block lifting required for the production of ships and offshore plants, block supporter placement in the dock, marine erection. Further, the GIS-based dock and quay simulation system is configured to support placement of a dry dock and a quay wall required for the production of ships and offshore plants, and optimization of facility operation, based on geographical information within a shipyard. Further, the block monitoring and logistics simulation system is configured to support loading of steel plate and section steel, locating and transportation planning of processing logistics, subsidiary materials, assembly blocks, design equipment, and single items, standard production plan for block allocation and layout by lot number of an assembly plant and a pre-erection yard, block layout planning for a painting factory, and block layout planning for quay outfitting.

In order for the shipbuilding and marine industry to have technological competitive advantage, productivity improvement through development of high-efficiency production technology is essential. As one of these efforts, the field of simulation of production for ships and offshore plants emerged, and a simulation technology specialized for shipyards is required. For integration considering recyclability and scalability, the simulation framework for production of ships and offshore plants has been developed, and based on the simulation, studies are under way to develop application systems that are on-site user friendly. In order to develop the integrated solution for simulation-based production of ships and offshore plants, it is necessary to derive and analyze needs of the site users in the shipyard, the end user, and to develop solutions based on the needs. Thus, in the present invention, the visualization engine and the analysis engine are separated from each other so that the end user can access the application system from the same view (viewpoint), and elements of the simulation framework for production of ships and offshore plants are derived by reflecting user needs.

According to the present invention, it is possible to simulate the building process and method verification of ships and offshore plants, optimization and verification of facilities and layout, and optimization of production management based on various production simulations in the shipyard, and based thereon, it is possible to support pre-verification, decision-making during work, and post-management, whereby the present invention is a technology that is widely used in the field of shipbuilding and marine industry to realize its practical and economic value.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An integrated solution for simulation-based production of ships and offshore plants, the integrated solution being based on a simulation framework for production of ships and offshore plants, the simulation framework including:
a simulation engine configured to calculate and analyze a simulation according to interaction of kernels, as an analysis interpretation module including mathematical calculation;
a visualization engine configured to allow a visualization object calculated in the simulation engine to be represented in a same view (viewpoint) from a user's point of view; and
an analysis engine configured to provide an expression function for analysis results of the simulation engine, and to use results calculated in the simulation engine as neutral output data, the integrated solution comprising:
a planning validation simulation system configured to support mutual verification of production process planning and production scheduling from an integrated viewpoint of production planning, according to the calculation and analysis results of the simulation engine;
a crane block lifting and erection simulation system configured to support verification of a lug position, simulation of block defamation and stress, simulation of interaction between a floating crane and a floating dock, and motion simulation of blocks when lifting for verification and planning of operations, such as block turn-over and block lifting required for the production of ships and offshore plants, block supporter placement in the dock, marine erection, according to the calculation and analysis results of the simulation engine;
a GIS-based dock and quay simulation system configured to support placement of a dry dock and a quay wall required for the production of ships and offshore plants, and optimization of facility operation, based on geographical information within a shipyard according to the calculation and analysis results of the simulation engine; and
a block monitoring and logistics simulation system configured to support loading of steel plate and section steel, locating and transportation planning of processing logistics, subsidiary materials, assembly blocks, design equipment, and single items, standard production plan for block allocation and layout by lot number of an assembly plant and a pre-erection yard, block layout planning for a painting factory, and block layout planning for quay outfitting, according to the calculation and analysis results of the simulation engine, wherein
the simulation framework for the production of ships and offshore plants, the planning validation simulation system, the crane block lifting and erection simulation system, the GIS-based dock and quay simulation system, and the block monitoring and logistics simulation system are separable from each other.

2. The integrated solution of claim 1, configured to represent and share an interface between the kernels in a standardized form.
